(19) United States
(12) Patent Application Publication
(10) Pub. No.: US 2024/0011605 A1
(43) Pub. Date: Jan. 11, 2024

(54) CYLINDRICAL SUB-ATMOSPHERIC PRESSURE REGULATING DEVICE FOR INSERTION INTO A GAS CYLINDER

(71) Applicant: ROTAREX S.A., Lintgen (LU)

(72) Inventors: Philippe SCHMITZ, Steinsel (LU); Etienne KAICHINGER, Kemplich (FR); Stephan SELLEN, Wehingen (DE)

(21) Appl. No.: 18/254,498

(22) PCT Filed: Nov. 25, 2021
(86) PCT No.: PCT/EP2021/083043

§ 371 Date: May 25, 2023

(30) Foreign Application Priority Data
Nov. 25, 2020 (LU) 102229

(51) Int. Cl. F17C 13/04

(52) U.S. Cl. CPC F17C 13/04; F17C 2205/0338; F17C 2201/0104; F17C 2205/0329; F17C 2205/0385; F17C 2205/0391; F17C 2270/0518

(57) ABSTRACT

A pressure regulating device for compressed gas, comprising a body with a gas inlet, a gas outlet and a gas passage fluidly interconnecting the gas inlet and gas outlet; a valve device with a seat in the gas passage and an obturator configured for cooperating with the seat; a regulator housed in a cavity of the body, downstream of the valve device, delimiting with the cavity a regulating chamber with a geometry that varies with the pressure in the regulating chamber, and actuating the obturator for regulating a flow of gas through the valve device; wherein the body is tubular over its whole length, with a nominal outer diameter that is a maximum outer diameter of the body.

### CROSS-REFERENCE TO RELATED APPLICATIONS

The present invention is the US national stage under 35 U.S.C. § 371 of International Application No. PCT/EP2021/083043 which was filed on Nov. 25, 2021, and which claims the priority of application LU102229 filed on Nov. 25, 2020 the contents of which (text, drawings and claims) are incorporated here by reference in its entirety.

### FIELD

The invention is directed to the field of delivery of gas stored in a compressed state in gas cylinders, in particular dangerous gases used for the production of semiconductors

### BACKGROUND

Prior art patent document published EP 1 328 756 B1 discloses a sub-atmospheric pressure regulating device designed for being located inside a gas cylinder. To that end, the collar of the gas cylinder needs to be enlarged so as to allow the pressure regulating device to be inserted there through. Locating a pressure regulating device inside the gas cylinder is interesting for dangerous gases, like the gases used in the semiconductor industry, for it protects the pressure regulating device from external actions that could damage it.

Prior art patent document published GB 787 192 discloses a gas regulator integrating a pressure relief valve. The gas regulator comprises a valve device and a regulator arranged in the body and forming a regulating chamber downstream of the valve device. The regulator comprises a below attached to a fixed part and to a mobile part of the regulator, thereby forming a sealed inner chamber working as a spring. The regulating chamber is the space between the inner walls of the cavity in the body and the outer surface of the regulator. The fixed part of the regulator rests on a tube via a ball, where the position of the tube can be adjusted by a hand-wheel. The ball in contact with the tube forms the pressure relief valve in that in case of an uncontrolled increase of pressure at the outlet, i.e., in the regulating chamber, the regulator will be further compressed and will then further contracts and thereby move the ball off the tube and allow gas to escape. This regulator construction is interesting in that the regulator forming a sealed inner volume achieves a pressure regulation which is independent of the atmospheric pressure. This construction is however relatively bulky and is likely to show unwanted pressure variation when the outlet flow is subject to variations.

In some applications like for example in the semiconductor industry, the end gas consumer can be a flow regulator working in sub-atmospheric conditions, i.e., at pressures below the atmospheric pressure. Such a flow regulator can be controlled by the semiconductor producing machine and thereby change the flow rate from zero to a nominal value and vice versa. When such flow variations occur, the pressure regulating device fluidly connected directly upstream of the flow controller can show unwanted variations of the outlet pressure, to such an extent that it can disturb the flow controller, i.e., setting said flow controller to a failure mode.

### SUMMARY

The invention has for technical problem to overcome at least one of the drawbacks of the above cited prior art. More specifically, the invention has for technical problem to provide a pressure regulating device that is suitable for applications where a special attention to the security and stability of the outlet pressure when the outlet flow varies is given.

The invention is directed to a pressure regulating device for compressed gas, comprising: a body with a gas inlet, a gas outlet and a gas passage fluidly interconnecting the gas inlet and gas outlet; a valve device with a seat in the gas passage and an obturator configured for cooperating with the seat; a regulator housed in a cavity of the body, downstream of the valve device, delimiting with the cavity a regulating chamber with a geometry that varies with the pressure in the regulating chamber, and actuating the obturator for regulating a flow of gas through the valve device; wherein the body is tubular over its whole length, with a nominal outer diameter that is a maximum outer diameter of the body.

According to an exemplary embodiment, the body comprises a main portion with the nominal outer diameter and at least one end portion with the nominal outer diameter and attached to the main portion.

According to an exemplary embodiment, the attachment of the at least one end portion to the main portion of the body is by welding.

According to an exemplary embodiment, one end of the main portion houses the valve device and comprises an annular groove around the seat.

According to an exemplary embodiment, the body comprises a tubular wall with an inner surface forming the cavity.

According to an exemplary embodiment, the obturator comprises a poppet located on an upstream side of the seat and configured for contacting the seat, and a stem extending from the poppet through the seat, the stem being attached to the regulator.

According to an exemplary embodiment, the stem comprising a conical portion adjacent the poppet and showing a radial play with the seat of less than 0.02 mm

According to an exemplary embodiment, the cavity comprises a bottom adjacent the seat, the pressure regulating device comprising a compression wave spring resting on the bottom and acting on the regulator.

According to an exemplary embodiment, the regulator comprises a shouldered end face engaging with the compression wave spring.

According to an exemplary embodiment, the regulator comprises a movable part in vis-à-vis of the valve device, configured for moving along an inner surface of the cavity and actuating the obturator.

According to an exemplary embodiment, the regulator comprises an open ring mounted around the movable part of the regulator and configured for contacting the inner surface of the cavity.

According to an exemplary embodiment, the regulator comprises a fixed part opposed to the valve device and engaging with a screw configured for adjusting the position of the fixed part.

According to an exemplary embodiment, the screw comprises a conical front face contacting an annular concave conical surface of the fixed part of the regulator, forming the engagement between the screw and fixed part.

According to an exemplary embodiment, the engagement between the screw and the fixed part of the regulator is configured to centre the fixed part showing a radial play in the cavity.

According to an exemplary embodiment, the screw threadably engages with the at least one end portion.

According to an exemplary embodiment, the regulator comprises a bellow with a first end attached in a gas tight fashion to the fixed part and a second end attached in a gas tight fashion to the movable part, thereby forming a sealed inner volume.

According to an exemplary embodiment, the fixed part and the movable part of the regulator engage mutually in a sliding and longitudinally guided fashion inside the bellow.

According to an exemplary embodiment, the valve device is a first valve device and the regulator is a first regulator, the pressure regulating device further comprising a second valve device fluidly in series with and upstream of the first valve device, with a seat in the gas passage and an obturator configured for cooperating with the seat, and a second regulator housed in a cavity of the body, downstream of the second valve device, delimiting with the cavity a regulating chamber with a geometry that varies with the pressure in the regulating chamber, and actuating the obturator for regulating a flow of gas through the second valve device.

According to an exemplary embodiment, the main portion of the body is a first main portion housing the first valve device and the first regulator, the body further comprising a second main portion housing the second valve device and the second regulator.

According to an exemplary embodiment, the pressure regulating device is configured for delivering a flow of gas in the presence of an absolute pressure at the gas outlet that is less than 0.9 bar.

According to an exemplary embodiment, the pressure regulating device further comprises a port fluidly connected via a plug to a sealed chamber of the regulator and configured for fluidly connecting an external source of auxiliary gas to the sealed chamber for adjusting a pressure of the auxiliary gas in the sealed chamber.

According to an exemplary embodiment, the port opens out of the body.

According to an exemplary embodiment, the port shows a main axis that is transversal to a longitudinal axis of the pressure regulating device, in various instances radial to the longitudinal axis.

According to an exemplary embodiment, the plug comprises a threaded portion engaging with a fixed portion of the regulator, and a conical needle portion engaging with an auxiliary seat formed in the fixed portion.

According to an exemplary embodiment, the plug is entirely located in a channel between the port and the sealed chamber of the regulator.

According to an exemplary embodiment, the plug comprises an internal passage for the auxiliary gas between the threaded portion and the conical needle portion.

According to an exemplary embodiment, the plug comprises, at an end opposed to the sealed chamber of the regulator, an engagement surface for engaging with a tool by insertion of the tool into the port.

According to an exemplary embodiment, the engagement surface of the plug shows an insertion direction for the tool that is aligned with the port.

According to an exemplary embodiment, the engagement surface of the plug is configured such that the engagement with the tool is in rotation so that rotation of the tool rotates the plug.

According to an exemplary embodiment, the regulator comprises a fixed portion, and at least one flexible wall attached to the fixed portion and the movable portion in a gas-tight fashion, the sealed chamber of the regulator being delimited by the at least one flexible wall, the fixed portion and the movable portion.

Advantageously, the obturator is mechanically linked, in various instances fixed, to the movable portion of the regulator.

Advantageously, the at least one flexible wall is circular, bellow-shaped and metallic.

Advantageously, the port is located on cylindrical outer surface of the body, the cylindrical outer surface being able to engage in a gas-tight fashion with a source of auxiliary gas.

The invention is also directed to a device for a gas cylinder, comprising: a main body with a male threaded portion configured for engaging with a collar of the gas cylinder, a gas inlet in the male threaded portion, a gas outlet and a gas passage interconnecting the gas inlet with the gas outlet; a shut-off valve for the gas passage, housed in the main body; and a pressure regulating device fluidly connected to the gas inlet at the male threaded portion, configured for being inserted into the gas cylinder; wherein the pressure regulating device is according to the invention.

The invention can also be directed to a pressure regulating device for compressed gas, comprising: a body with a gas inlet, a gas outlet and a gas passage fluidly interconnecting the gas inlet and gas outlet; a valve device with a seat in the gas passage and an obturator configured for cooperating with the seat; a regulator housed in a cavity of the body, downstream of the valve device, delimiting with the cavity a regulating chamber with a geometry that varies with the pressure in the regulating chamber, and actuating the obturator for regulating a flow of gas through the valve device.

The invention can also be directed to a pressure regulating device, wherein the obturator comprises a poppet located on an upstream side of the seat and configured for contacting the seat, and a stem extending from the poppet through the seat, the stem being attached to the regulator.

The invention can also be directed to a pressure regulating device, wherein the stem comprises a conical portion adjacent the poppet and showing a radial play with the seat of less than 0.02 mm

The invention can also be directed to a pressure regulating device, wherein the cavity comprises a bottom adjacent the seat, the pressure regulating device comprising a compression wave spring resting on the bottom and acting on the regulator. The wave spring can comprise at least four waves per turn, each wave forming a contact area.

The invention can also be directed to a pressure regulating device, wherein the regulator comprises a shouldered end face engaging with the compression wave spring.

The invention can also be directed to a pressure regulating device, wherein the regulator comprises a movable part in vis-à-vis of the valve device, configured for moving along an inner surface of the cavity and actuating the obturator.

The invention can also be directed to a pressure regulating, wherein the regulator comprises an open ring mounted around the movable part of the regulator and configured for contacting the inner surface of the cavity.

The invention can also be directed to a pressure regulating device, the regulator comprises a fixed part opposed to the valve device and engaging with a screw configured for adjusting the position of the fixed part.

The invention can also be directed to a pressure regulating device, wherein the screw comprises a conical front face contacting an annular concave conical surface of the fixed part of the regulator, forming the engagement between the screw and fixed part.

The invention can also be directed to a pressure regulating, wherein the engagement between the screw and the fixed part of the regulator is configured to centre the fixed part showing a radial play in the cavity.

The invention can also be directed to a pressure regulating device, wherein the screw threadably engages with the body.

The invention can also be directed to a pressure regulating device, wherein the regulator comprises a bellow with a first end attached in a gas tight fashion to the fixed part and a second end attached in a gas tight fashion to the movable part, thereby forming a sealed inner volume.

The invention can also be directed to a pressure regulating device, wherein the fixed part and the movable part of the regulator engage mutually in a sliding and longitudinally guided fashion inside the bellow.

The invention can also be directed to a pressure regulating device for compressed gas, comprising: a body with a gas inlet, a gas outlet and a gas passage fluidly interconnecting the gas inlet and gas outlet; a valve device with a seat in the gas passage and an obturator configured for cooperating with the seat; a regulator housed in a cavity of the body, downstream of the valve device, delimiting with the cavity a regulating chamber with a geometry that varies with the pressure in the regulating chamber, and actuating the obturator for regulating a flow of gas through the valve device; wherein the body comprises a main portion and at least one end portion attached to the main portion.

The invention can also be directed to a pressure regulating device, wherein the attachment of the at least one end portion to the main portion of the body is by welding.

The invention can also be directed to a pressure regulating device, wherein one end of the main portion houses the valve device and comprises an annular groove around the seat.

The invention can also be directed to a pressure regulating device, wherein the body comprises a tubular wall with an inner surface forming the cavity.

The invention can also be directed to a method for assembling a pressure regulating device, comprising a step of welding the main portion and at least one end portion together by applying a welding arc along a circular joint between the portions.

The invention can also be directed to a method comprising a step of placing a cooling ring around the main portion of the body, adjacent the circular joint, prior welding, so as to avoid overheating of the valve device.

The invention can also be directed to a method having the pressure regulating device, and the cooling ring axially overlapping with the annular groove.

The invention is particularly interesting in that it provides advantages of compactness in particular in a radial direction, as well as of pressure stability when the outlet flow and/or the inlet pressure is varied.

### DRAWINGS

FIG. 1 is an exemplary perspective view of a device for a gas cylinder, comprising a pressure regulating device according to the invention.

FIG. 2 is an exemplary sectional view of a first embodiment of the pressure regulating device of FIG. 1 according to the invention.

FIG. 3 is an exemplary sectional view of a second embodiment of the pressure regulating device of FIG. 1 according to the invention.

### DETAILED DESCRIPTION

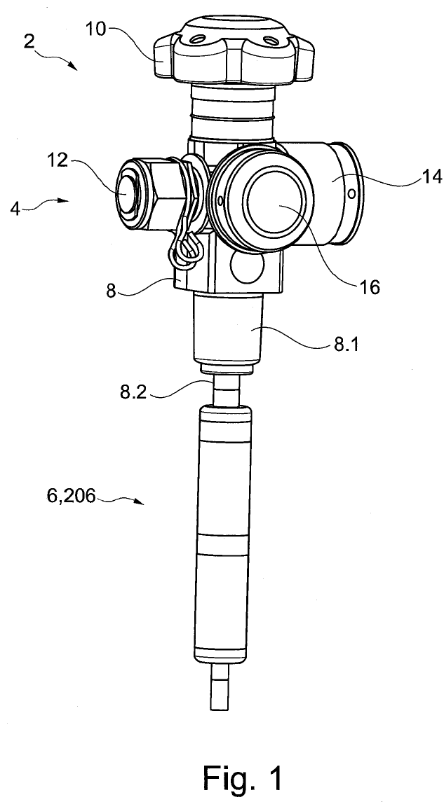

FIG. 1 is a perspective view of a device for the delivery of gas from a gas cylinder.

The device 2 comprises an external portion 4 and an internal portion 6. The internal portion is intended to be located inside the gas cylinder whereas the external portion 4 is intended to be located outside the gas cylinder, for instance directly above the collar of the gas cylinder.

The external portion 4 comprises, essentially, a main body 8 of the device 2, a shut-off valve 10, a gas outlet port 12, a refill port 16 and a refill valve 14. The main body 8 comprises a male threaded portion 8.1 designed for engaging with a collar of a gas cylinder. The gas passage (not visible) is formed inside the main body 8 so as to fluidly interconnect a gas inlet (not visible) formed at the male threaded portion 8.1 with a gas outlet at the gas outlet port 12. The shut-off valve 10 is for instance manually operated and designed for selectively shutting-off or opening the gas passage. The refill port 16 can be fluidly connected to a refill passage that extends through the male threaded portion 8.1 in parallel to the gas passage and open outs at a front face of the male threaded portion 8.1.

The above elements are as such known from the skilled person and do not need to be further detailed.

The main body 8 comprises also, at the male threaded portion 8.1 a port 8.2 which is for instance formed as a tubular portion unitary with the male threaded portion 8.1, for being mechanically, e.g., welded, and fluidly connected to the second portion 6, for instance the pressure regulating device, of the device 2.

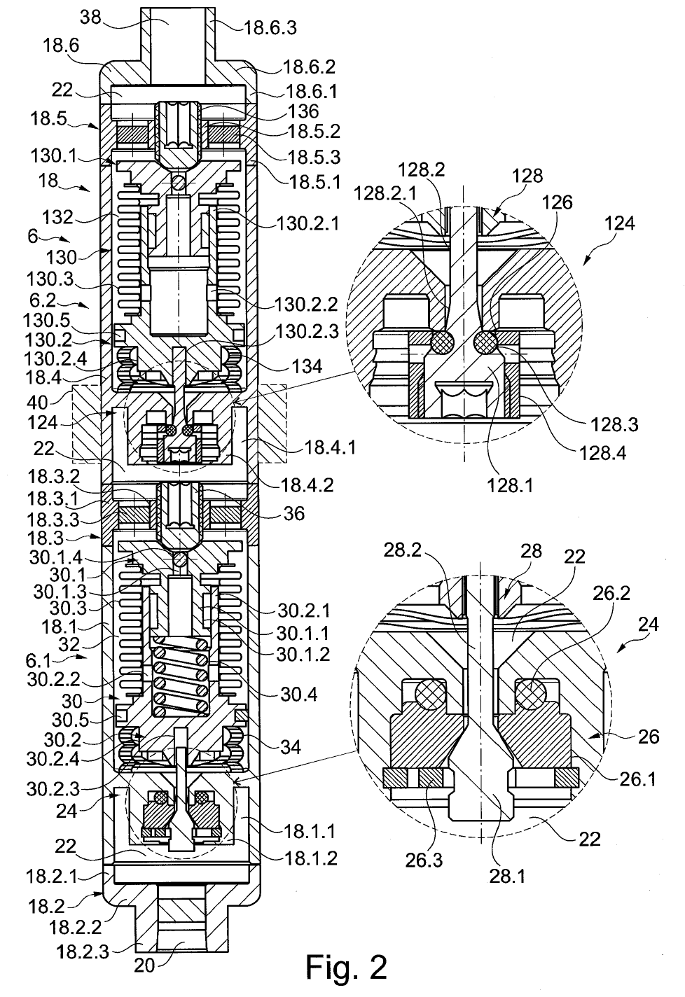

FIG. 2 is a sectional view of a first embodiment of the pressure regulating device 6 of the device of FIG. 1.

The pressure regulating device 6 comprise two stages, i.e., a first stage 6.1 and a second stage 6.2. As this is apparent, the pressure regulating device 6 comprises a body 18 that is generally tubular over its whole length, with a nominal outer diameter that is a maximum outer diameter of the body. In other words, the nominal outer diameter determines whether the pressure regulating device 6 can be inserted through a collar of a gas cylinder. If the nominal outer diameter is less than the inner diameter of the collar, then it can be inserted there through whereas if the nominal outer diameter is greater than the inner diameter of the collar, then it cannot be inserted there through. The body 18 comprises several portions 18.1, 18.2, 18.3, 18.4, 18.5 and 18.6, all tubular with the same nominal outer diameter, arranged end-to-end along a longitudinal axis and attached to each other, in various instances by orbital-welding.

The first stage 6.1 of the pressure regulating device 6 comprises a main body portion 18.1 and two end portions 18.2 and 18.3 at respective ends of the main portion 18.1. The end portion 18.2 forms a gas inlet 20 of the pressure regulating device 6 and of the first stage 6.1. That end portion 18.2 is generally cap-shaped; it comprises a tubular part 18.2.1 arranged against the main portion 18.1 of the body 18, a lid part 18.2.2 and a port 18.2.3 forming a pipe portion of a reduced diameter forming the gas inlet 20. The end portion 18.3, opposed to the end portion 18.2, comprises a tubular part 18.3.1 arranged against the main portion 18.1 of the body 18 and a transversal wall 18.3.2 with orifices 18.3.3, for instance housing sintered filters, forming a gas outlet of the first stage 6.1 of the pressure regulating device 6. A gas passage 22 is provided in the assembly of the main portion 18.1 and end portions 18.2 and 18.3 of the body 18, interconnecting the gas inlet 20 with the gas outlet of the first stage 6.1 of the pressure regulating device 6.

A valve device 24 is provided in the body 18, for instance in the main portion 18.1 thereof. The valve device 24 comprises a seat 26 arranged in the gas passage 22, and an obturator 28 that is movable for cooperating with the seat 26. The obturator 28 comprises a poppet 28.1 for contacting the seat 26 is a gas tight fashion and located on an upstream side of the seat 26, and a stem 28.2 extending longitudinally from the poppet 28.1 through the seat 26 to a downstream side of the seat 26. The seat 26 can comprise a ring 26.1 made of a non-metallic material with an inner conical surface that is contacted by the poppet 28.1 of the obturator 28. That ring is housed in a corresponding cavity formed in the main portion 18.1 of the body 18. A gasket, for instance an O-ring 26.2 can be provided in the cavity between the ring 26.1 and a circular groove of the cavity for providing a gas tight barrier between the ring 26.1 and the main portion 18.1 of the body 18. A snap ring 26.3 can be provided for retaining the ring 26.1 in the cavity.

A regulator 30 is provided in a cavity 32 of the main portion 18.1 of the body 18, the cavity being directly downstream of the valve device 24 and forming a portion of the gas passage 22. That cavity 32 is cylindrical and delimited radially by an inner surface of a cylindrical wall of the main portion 18.1 of the body. 18. The obturator 28 of the valve device 24 is attached to the regulator 30 which delimits with the cavity a regulating chamber with a geometry that varies with the pressure in the chamber. The regulator 30 forms indeed a sealed chamber and can contracts longitudinally further to an increase of pressure in the regulating chamber. The sealed chamber is filled with gas so as to provide a resilient reacting force when compressing the regulator 30.

More specifically, the regulator 30 comprises a fixed part 30.1, a movable part and a bellow 30.3 interconnecting the fixed and movable parts. The bellow is attached at one end to the fixed part 30.1 and at the opposed end to the movable part 30.2. These two attachments are gas tight, e.g., by welding, the bellow being metallic. As this is apparent, the fixed and movable parts 30.1 and engage mutually in a sliding fashion along the longitudinal axis. To that end and as a matter of example, the fixed part 30.1 comprises a spindle portion 30.1.1 that engages inside a cylindrical wall 30.2.1 of the movable part 30.2, that engagement being in a sliding fashion. More specifically, the spindle portion shows an outer circular groove carrying a sliding ring 30.1.2 showing a low friction coefficient at a contact with the cylindrical wall 30.2.1. That contact does not need to be gas tight. The cylindrical wall 30.2.1 can show at least one aperture for proving a gas communication between the inner and outer volumes thereof, thereby avoiding pressure differences between these two volumes to build up during operation of the regulator 30, which would otherwise disturb a proper functioning thereof. As this is apparent, a compression spring 30.4 can be provided in the inner volume, i.e., between the fixed and movable parts 30.1 and so as to provide an additional resilient force to the resilient force exerted by the gas comprised in the sealed chamber (corresponding essentially to the sum of the above inner and outer volumes). The presence of the compressive spring can depend on the wished pressure difference between the inlet and the outlet during operation.

The fixed part 30.1 of the regulator can show a channel 30.1.3 for filling the sealed chamber with an adequate mass of gas and/or for adjusting that mass of gas. For instance, that channel 30.1.3 is closed by a ball 30.1.4 that is forced into the channel which shows an inner diameter that advantageously tapers. The ball can be replaced by a check valve. Alternatively, the channel 30.1.3 may not be present, meaning that the chamber is definitely closed once the bellow is attached in a gas tight fashion to each of the fixed and movable parts 30.1 and 30.2.

The movable part 30.2 of the regulator 30 comprises at its front face in vis-à-vis of the valve device 24 an inner thread 30.2.3 receiving a corresponding threaded end of the stem 28.2 of the obturator 28. The obturator 28 is then rigidly attached to the movable part 30.2 of the regulator 30.

A compression spring 34 can be provided between a bottom of the cavity 32, adjacent to the seat 26, and the movable part 30.2 of the regulator 30. That compression spring 34 acts against the resilient force of gas in the sealed chamber of the regulator and of the optional compression spring 30.4 housed in the regulator 30. The compression spring 34 is advantageously a wave spring, i.e., commonly known also as Smalley® spring. A wave spring is a spring made up of pre-hardened flat wire in a process called on-edge coiling. The compression spring 34 is advantageously a multi-turn wave spring, optionally with shim ends. The number of turns can be at least two, in various instances at least three. The number of waves, i.e., contact areas, per turn can be at least 4, in various instances at least 5, for example at least 6. In the present embodiment, the number of turns is three. Such a spring is particularly interesting and useful in the present configuration in that the resilient force exerted on the regulator 30, for instance on the movable part 30.2 thereof, is substantially better distributed circumferentially. This is particularly useful in the present case because the movable part 30.2 of the regulator 30 is not exactly radially guided in the cavity 32. The use of a classical compression spring would indeed result in an imbalance in the load distribution around the longitudinal axis, that would tend to move radially the movable part 30.2 and the obturator 28, potentially leading to a lack of progressivity and precision in the gas pressure regulation.

The regulator 30 can comprise a guiding open ring 30.5 mounted on the movable part 30.2, for instance in an outer circular groove formed on the movable part. That guiding ring is open for allowing the gas to flow to the outlet along the regulating chamber delimited by the cavity 32 and the regulator 30. The guiding open ring 30.5 shows an outer diameter that is less than the inner diameter of the cavity 32, so as to avoid a permanent contact and unwanted frictional forces that would otherwise impair a proper and accurate regulation. The purpose of the guiding open ring 30.5 is for absorbing possible radial movements of the regulator in case of manipulation with shocks of the pressure regulating device 6.

As this is apparent, the movable part 30.2 can show a shouldered front face in vis-à-vis of the valve device 24, for receiving the compression spring 34.

The fixed part 30.1 of the regulator is held in position, axially and radially, only by the screw 36. The latter threadably engages in the transversal wall 18.3.2 of the end portion 18.3 of the body 18. It shows a conical front face contacting an annular concave conical surface of the fixed part 30.1 of the regulator 30. As this is apparent, the fixed part 30.1 shows an outer diameter that is less than the corresponding inner diameter of the cavity 32, so as to form an annular section for the gas passage 22 to the outlet. The screw 36 is an adjustment screw in that it allows not only to position and centre the fixed part 30.1 of the regulator 30 but also to adjust its pre-compression and thereby the outlet pressure.

The second stage 6.2 of the pressure regulating device 6 is similar to the first stage 6.1 thereof. It differs from the second stage 6.1 essentially only in the construction of the body 18 and in the valve device 124. Reference numbers of the first stage are used for designating the same or corresponding internal elements in the second stage, these numbers being however incremented by 100. Reference is made to the description of these elements in connection with the first stage.

The body of the second stage 6.2 comprises the main portion 18.4 housing the valve device 124, the regulator 130 and the compression spring 134, and the portions end portions 18.5 and 18.6. Contrary to the first stage, the two end portions 18.5 and 18.6 of the body 18 are arranged end to end against the downstream end of the main portion 18.4, i.e., opposed to the first stage 6.1. The main portion 18.4 of the second stage 6.2 is similar to the main portion 18.1 of the first stage 6.1. The end portion 18.5 is similar to the end portion 18.3 of the first stage 6.1, i.e., it comprises a tubular part 18.5.1 arranged against the main portion 18.4 of the body 18 and a transversal wall 18.5.2 with orifices 18.5.3, for instance housing sintered filters, forming a gas outlet of the second stage 6.2, being for instance the gas outlet 38 of the pressure regulating device 6.

The end portion 18.6 forms the gas outlet 38 of the pressure regulating device 6 and of the second stage 6.2. That end portion 18.6 is generally cap-shaped; it comprises a tubular part 18.6.1 arranged against the end portion 18.5 of the body 18, a lid part 18.6.2 and a port 18.6.3 forming a pipe portion of a reduced diameter forming the gas outlet 38.

The valve device 124 is somehow different from the valve device 24 of the first stage 6.1 in that the seat 126 is formed of metallic material, for instance integrally with the main portion 18.4 of the body 18 whereas the obturator 128 carries on its poppet 128.1 a gasket 128.3 of elastomeric material, for instance an O-ring, held against the poppet 128.1 by a sleeve 128.4. The stem 128.2 of the obturator 128 shows at a position directly adjacent to the poppet 128.1 a circular outer groove receiving the gasket 128.3. The sleeve is slid along the stem 128.2 and shows an inner circular surface that contacts an outer circular portion of the gasket, and an inner larger bore that is secured to an outer surface of the poppet 128.1. The gasket 128.3 is thereby trapped between the circular outer groove on the stem 128.2 and the corresponding inner circular surface of the sleeve 128.4. The latter shows also a front face in vis-à-vis of the seat 126 and that can contact the seat 126 when the gasket is deformed up to a given level.

The valve device 124 differs also from the valve device 24 of the first stage 6.1 in that the stem 128.2 shows a conical portion 128.2.1 adjacent the poppet 128.1 and showing a reduced radial play with the gas passage through the seat 126, e.g., of less than 0.02 mm. The radial play is the difference between the radius of the gas passage through the seat 126 and the radius of the conical portion 128.2.1 of the stem 128.2, when centred, at the axial position where that difference is minimum. Advantageously, the radial play can be of 0.01 mm or less.

Another difference between the second stage 6.2 and the first stage 6.1 of the pressure regulating device 6 is the absence of compression spring inside the regulator 130.

The above differences of the second stage 6.2 over the first one are because the second stage 6.2 works at lower pressures than the first one. More particularly, the elastomeric material involved in the contact with the seat in the valve device 124 allows to achieve a gas tight contact with reduced forces and thereby a higher sensitivity and stability in the presence of variations in the outlet flow. The end consumer, in particular in the field of ion implantation in the manufacture of semiconductors, can comprise a flow regulator to which the outlet of the device is connected. That regulator, depending on various parameters of manufacturing process, varies the flow of gas meaning that the pressure regulating device needs to react quickly and in a controller manner to these variations. In case the pressure at the outlet of the pressure regulating device deviates from the nominal pressure by more than a given amount, even over a short period of time, this can bring the flow regulator to a failure status leading to a stop of production. The above construction of the valve device is particularly adapted for quickly and properly responding to such flow variations at the outlet.

In addition, the conical portion 128.2.1 of the stem 128.2 further increases the stability of second stage as detailed above, for it keeps the obturator 128 and the movable part 130.2 of the regulator in a centred position and, in parallel, provides a diverging passage for the gas directly downstream of the seat 126 and the gasket 128.3 contacting the seat that converts most of the speed of gas into static pressure and thereby provides stability in the regulating chamber (delimited between the cavity 132 and the regulator 130).

Assembly of the pressure regulating device 6 is as follows:
The regulators 30 and 130 are pre-assembled including welding of the bellow to the respective fixed and movable parts of the regulator. A check valve or any equivalent means can be provided in the fixed part of the regulator, for filling and/or adjusting the mass of gas contained in the sealed chamber thereof. Also, the different elements like the body portions 18.1-18.6 and the elements of the valve devices 24 and 124 are manufactured prior assembly.
The first stage 6.1 is assembled by mounting the valve device 24 at the inlet end of the main portion 18.1 of the body and inserting the regulator 30 through the outlet end of the main portion 18.1. The stem 28.2 of the obturator 28 can then be screwed into and assembled to the regulator 30.
Thereafter, the end portion 18.2 forming the inlet 20 is assembled to the main portion 18.1, e.g., by orbital welding at the joint between the tubular parts thereof. Similarly, the end portion 18.3 forming the outlet of the first stage 6.1, equipped with the screw 36, is assembled to the main portion 18.1, e.g., by orbital welding at the joint between the tubular parts thereof. These two operations can be done in the one or other order.
The first stage 6.1 is then adjusted by acting on the screw 36. A special equipment can be required for connecting the outlet of the first stage 6.1 while being able to act on the screw 36.
The second stage 6.2 can be assembled similarly to the first stage 6.1, either in parallel, i.e., independently of the first stage, whereby both stages are assembled are then assembled together. Alternatively, the second stage 6.2 can be assembled on the first stage 6.1, i.e., by assembling the main portion 18.4 of the body 4, equipped with the valve device 124 and the regulator 130, and thereafter successively assembling the end portions 18.5 and 18.6 of the body 18.

The above mentioned orbital welding operation can be achieved by means of a rotating tool that is mounted around the body 18 and configured for guiding a welding head circumferentially around the joint between the two body portions to be assembled. The welding head is designed for producing an electrical arc with the body. With reference to the above assembly procedure, the body portions are assembled together by orbital welding while the valve devices and regulators are already mounted in the main portions 18.1 and 18.4 of the body 18. It can therefore be appropriate to provide specific cooling to the body 18 during the welding operation, for protecting these elements, in particular the non-metallic ones, i.e., the seat 26.1 and gasket 26.2 of the valve device 24 of the first stage 6.1 and the gasket 128.3 of the valve device 124 of the second stage 6.2. To that end, a cooling ring as the one 40 schematically represented in FIG. 2 can be slid around the main portion 18.4 or 18.1 of the body 18, more specifically at the level of the valve device 124 or 24 for protecting it from the heat produced during welding.

As this is apparent in FIG. 2, each of the main portions 18.1 and 18.4 of the body 18 shows at the inlet end thereof a circular groove 18.1.1 or 18.4.1 formed around the valve device 24 or 124. Each of these grooves 18.1.1 or 18.4.1 extends longitudinally past the height or level of the non-metallic element(s) of the valve device, so that the heat produced at the adjacent joint with the adjacent end portion 18.2 or 18.3 can be transmitted radially to the central portion 18.1.2 or 18.1.2 housing the non-metallic element(s).

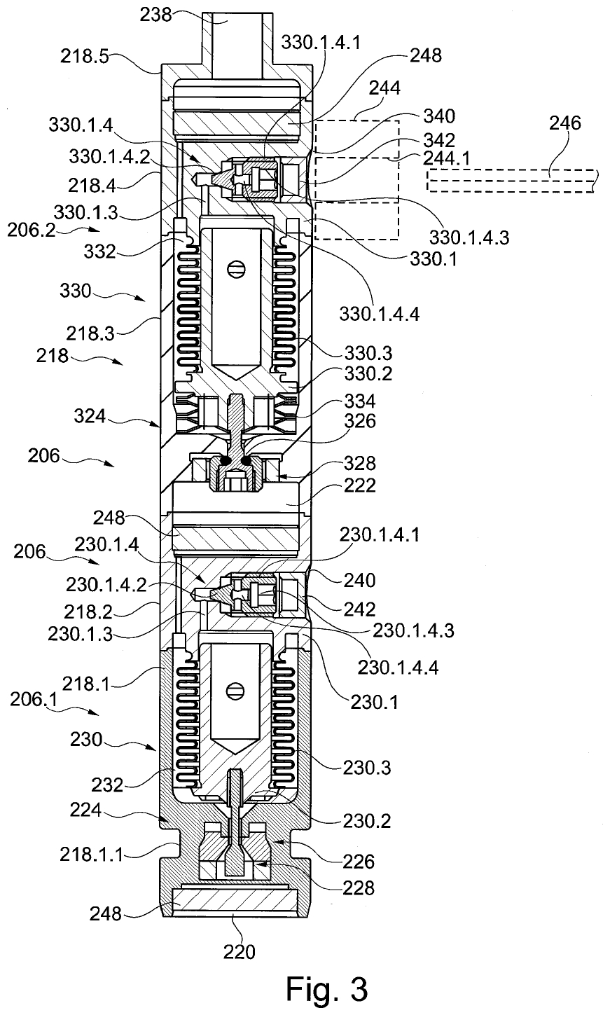

FIG. 3 is a sectional view of a second embodiment of the pressure regulating device of FIG. 1. The reference numbers of the first embodiment in FIG. 2 are used for designating the same or corresponding elements, these reference numbers being however incremented by 200. It is referred to the description of these elements in connection with FIG. 2. Specific reference numbers are used for designating the specific elements.

The pressure regulating device 206 of FIG. 3 differs from the pressure regulating device 6 of FIG. 2 essentially in the construction of the regulators 230 and 330. Instead of having their sealed chambers prefilled with a fixed and predetermined mass of gas and closed in a in various instances definite manner by a plug like the ball 30.1.4 in the first stage 6.1 in FIG. 2, they are sealed by plugs 230.1.4 and 330.1.4 operable and located the channels 230.1.3 and 330.1.3 opening out transversally, in various instances radially, to the ports 240 and 340, respectively. Each of the ports 240 and 340 can be connected to an external source 244 of auxiliary gas for adjusting the pressure in the chambers of the regulator 230 or 330 while the corresponding plug 230.1.4 or 330.1.4 is operated, via an engagement tool 246, to open the corresponding channel 230.1.3 or 330.1.3. Once the desired pressure is reached, the corresponding plug 230.1.4 or 330.1.4 is then further operated to close the corresponding channel 230.1.3 or 330.1.3. The external source of auxiliary gas can then be disconnected from the corresponding port 240 or 340.

The above adjustment solution essentially replaces the screws 36 and 136 of the first embodiment in FIG. 2 adjusting the positions of the fixed parts 30.1 and 130.1 of the regulators 30 and 130.

The fixed parts 230.1 and 330.1 of the regulators 230 and 330 are rigidly fixed with the body 218, for instance formed directly in the body parts 218.2 and 218.4, being however understood that the fixed portions of the regulators can be distinct form the body 218.

For instance, the plug 230.1.4 or 330.1.4 is entirely located in the channel 230.1.3 or 330.1.3 between the chamber of the regulator 230 or 330 and the port 238 or 338. This means that during pressure adjustment by means of the external source 244 of auxiliary gas and of the engagement tool 246, the latter 246 will be in contact with the auxiliary gas during adjustment and needs therefore to be in gas-tight connection relative to the auxiliary gas passage 244.1 of the external source 244 in fluid connection with the port 240 or 340. Such a rotating gas-tight connection between the engagement tool 246 and a body of the external source 244 can be achieved using one or more gaskets or seals mounted around a cylindrical surface portion of the tool and allowing a combined translational and rotation movement of the tool while providing gas-tight sealing.

The plug 230.1.4 or 330.1.4 comprises an outer threaded portion 230.1.4.1 or 330.1.4.1 engaging with a corresponding inner thread formed in the channel 230.1.3 or 330.1.3, and a needle portion 230.1.4.2 or 330.1.4.2 that is advantageously conical and that is configured to engage in a gas-tight fashion with an auxiliary seat formed in the channel 230.1.3 or 330.1.3 interconnecting the chamber and the port 240 or 340. The plug 230.1.4 or 330.1.4 further comprises at an end opposed to the needle portion 230.1.4.2 or 330.1.4.2, an engagement surface 230.1.4.3 or 330.1.4.3 for engaging with the engagement tool 246 by insertion of the tool into the port 240 or 340. The plug 230.1.4 or 330.1.4 can further comprise an internal passage 230.1.4.4 or 330.1.4.4 for the auxiliary gas between the threaded portion 230.1.4.1 or 330.1.4.1 and the conical needle portion 230.1.4.2 or 330.1.4.2.

Alternatively, the plug 230.1.4.1 or 330.1.4.1 can be only partly located in the channel 230.1.3 or 330.1.3 between the chamber of the regulator 230 or 330 and the port 240 or 340. More specifically, the engagement surface 230.1.4.3 or 330.1.4.3 can be fluidly located outside of the channel 230.1.3 or 330.1.3, whereby the plug 230.1.4.1 or 330.1.4.1 can be in a gas-tight sealed connection with the fixed portion 230.1 or 330.1 or second or fourth body part 218.2 or 218.4 forming the channel 230.1.3 or 330.1.3. In such a configuration, the tool 244 does not need to be in gas-tight connection with the body of the external source 242 of auxiliary gas.

A protective cap 242 or 342 can be provided on the port 240 or 340 so as to close the port and prevent dust or foreign material from entering the channel 230.1.3 or 330.1.3. The protective cap 242 or 342 can be made of plastic material or similar material softer than the metallic material of the body 218.

As this apparent in FIG. 3, a filter 248 can be provided in the gas inlet 220 which is for instance formed on the first body part 218.1. A filter 248 can be provided in the gas passage 222 between the two stages 206.1 and 206.2, for instance in the second body part 218.2. A filter 248 can also be provided in or close to the gas outlet 238, for instance in the fourth body part 218.4. The filter(s) 248 can be made of fritted material press fitted in to the corresponding body parts.

The above-described pressure regulator 206 is particularly advantageous in that its regulators 230 and 330 can be easily controlled and adjusted, not only in static conditions, i.e., in the absence of gas flow but also in dynamic conditions, i.e., when a flow of gas is outputted.

As this is apparent, the body 218 can comprise on its outer surface adjacent the gas inlet 220, for instance on the first body part 218.1, an outer circular ring 218.1.1 designed for being engaged with a dynamic adjustment tool, enabling the tool so be pressed against the body 218 at the gas inlet 220 and be in a sealed engagement with the gas inlet.

The pressure regulating devices 6 and 206 described here above can be configured for working in sub-atmospheric conditions, meaning that at least one of the stages 6.1 or 206.1 and 6.2 or 206.2 is normally closed at atmospheric pressure, i.e., about 1 bar and that the absolute pressure at the outlet needs to be less than 1 bar, e.g., less than 0.9 bar, for opening the closed stage and allow gas to be delivered.

The pressure regulating devices 6 and 206 described here above can also be configured for working in above atmospheric conditions, i.e., be normally opened and closing the gas passage when the outlet pressure reaches an upper limit greater than 1 bar.

The nominal outer diameter of the pressure regulating device 6 described here above can be less than 25 mm, allowing insertion thereof into most of the collar of commercially available gas cylinders.

The pressure regulating device 6 described here above instead of being a dual-stage one, can be a single stage one.

The pressure regulating devices 6 and 206 described here above instead of being an internal one, i.e., designed for being located inside a gas cylinder, can be an external one, i.e., designed for being located outside a gas cylinder.

What is claimed is:

1.-31. (canceled)

32. A pressure regulating device for compressed gas, said device comprising:
a body with a gas inlet, a gas outlet and a gas passage) fluidly interconnecting the gas inlet and gas outlet;
a valve device with a seat in the gas passage and an obturator configured for cooperating with the seat; and
a regulator housed in a cavity of the body, downstream of the valve device, delimiting with the cavity a regulating chamber with a geometry that varies with the pressure in the regulating chamber, and actuating the obturator for regulating a flow of gas through the valve device;
wherein the body is tubular over its whole length, with a nominal outer diameter along the regulator and the valve device that is a maximum outer diameter of the body.

33. The pressure regulating device according to claim 32, wherein the body comprises a main portion with the nominal outer diameter and at least one end portion with the nominal outer diameter and attached to the main portion.

34. The pressure regulating device according to claim 33, wherein the attachment of the at least one end portion to the main portion of the body is by welding.

35. The pressure regulating device according to claim 32, wherein the body comprises a tubular wall with an inner surface forming the cavity.

36. The pressure regulating device according to claim 32, wherein the obturator comprises a poppet located on an upstream side of the seat and configured for contacting the seat, and a stem extending from the poppet through the seat, the stem being attached to the regulator, and wherein the stem comprises a conical portion adjacent the poppet and showing a radial play with the seat of less than 0.02 mm.

37. The pressure regulating device according to claim 32, wherein the cavity comprises a bottom adjacent the seat, the pressure regulating device comprising a compression wave spring resting on the bottom and acting on the regulator, and wherein the regulator comprises a shouldered end face engaging with the compression wave spring.

38. The pressure regulating device according to claim 32, wherein the valve device is a first valve device and the regulator is a first regulator, the pressure regulating device further comprising a second valve device fluidly in series with and downstream of the first valve device, with a seat in the gas passage and an obturator configured for cooperating with the seat, and a second regulator housed in a cavity of the body, downstream of the second valve device, delimiting with the cavity a regulating chamber with a geometry that varies with the pressure in the regulating chamber, and actuating the obturator for regulating a flow of gas through the second valve device.

39. The pressure regulating device according to claim 38, wherein the main portion of the body is a first main portion housing the first valve device and the first regulator, the body further comprising a second main portion housing the second valve device and the second regulator.

40. The pressure regulating device according to claim 32, configured for delivering a flow of gas in the presence of an absolute pressure at the gas outlet that is less than 0.9 bar.

41. The pressure regulating device according to claim 32, further comprising a port fluidly connected via a plug to a sealed chamber of the regulator and configured for fluidly connecting an external source of auxiliary gas to the sealed chamber for adjusting a pressure of the auxiliary gas in the sealed chamber.

42. The pressure regulating device according to claim 41, wherein the port opens out of the body.

43. The pressure regulating device according to claim 41, wherein the port shows a main axis that is transversal to a longitudinal axis of the pressure regulating device, preferably radial to the longitudinal axis.

44. The pressure regulating device according to claim 41, wherein the plug comprises a threaded portion engaging with a fixed portion of the regulator and a conical needle portion engaging with an auxiliary seat formed in the fixed portion.

45. The pressure regulating device according to claim 44, wherein the plug comprises an internal passage for the auxiliary gas between the threaded portion and the conical needle portion.

46. The pressure regulating device according to claim 41, wherein the plug is entirely located in a channel between the port and the sealed chamber of the regulator.

47. The pressure regulating device according to claim 41, wherein the plug comprises, at an end opposed to the sealed chamber of the regulator, an engagement surface for engaging with a tool by insertion of the tool into the port.

48. The pressure regulating device according to claim 47, wherein the engagement surface of the plug shows an insertion direction for the tool that is aligned with the port.

49. The pressure regulating device according to claim 47, wherein the engagement surface of the plug is configured such that the engagement with the tool in rotation so that rotation of the tool rotates the plug.

41. The pressure regulating device according to claim 41, wherein the regulator comprises a fixed portion, a movable portion and at least one flexible wall attached to the fixed portion and the movable portion in a gas-tight fashion, the sealed chamber of the regulator being delimited by the at least one flexible wall, the fixed portion and the movable portion.

51. A device for a gas cylinder, said device comprising:
a main body with a male threaded portion configured for engaging with a collar of the gas cylinder, a gas inlet in the male threaded portion, a gas outlet and a gas passage interconnecting the gas inlet with the gas outlet;
a shut-off valve for the gas passage, housed in the main body; and
a pressure regulating device fluidly connected to the gas inlet at the male threaded portion, configured for being inserted into the gas cylinder;
wherein the pressure regulating device comprises:
a body with a gas inlet, a gas outlet and a gas passage) fluidly interconnecting the gas inlet and gas outlet;
a valve device with a seat in the gas passage and an obturator configured for cooperating with the seat; and
a regulator housed in a cavity of the body, downstream of the valve device, delimiting with the cavity a regulating chamber with a geometry that varies with the pressure in the regulating chamber, and actuating the obturator for regulating a flow of gas through the valve device;
wherein the body is tubular over its whole length, with a nominal outer diameter along the regulator and the valve device that is a maximum outer diameter of the body.
